(19) United States
(12) Patent Application Publication
(10) Pub. No.: US 2008/0040465 A1
(43) Pub. Date: Feb. 14, 2008

(54) Method and System for an Offsite Infrastructure Detection of an Enterprise Network

(75) Inventors: Corissa S. Koster, Vail, AZ (US); Jonathan D. Beard, Tucson, AZ (US); Louis D. Echevarria, Tucson, AZ (US); Andrew G. Hourselt, Tucson, AZ (US); Stefan Lehmann, Tucson, AZ (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 11/463,802

(22) Filed: Aug. 10, 2006

(51) Int. Cl. G06F 15/173

(52) U.S. Cl. 709/223

(57) ABSTRACT

A system implementing a method for an offsite detection of an infrastructure of an enterprise network. The method involves the system parsing enterprise machine data files into an offsite database supporting a logical linkage of each enterprise network interconnection among a plurality of machines of the enterprise network, and the system generating an enterprise network infrastructure profile of the enterprise network based on the offsite database logical linkage of each enterprise network interconnection among the plurality of machines of the enterprise network.

### FIELD OF THE INVENTION

The present invention generally relates to an infrastructure of an enterprise network. The present invention specifically relates to an enterprise offsite support system having the capability of to perform a detection of the infrastructure of the enterprise network.

### BACKGROUND OF THE INVENTION

An infrastructure of the enterprise network can be based on one or more machine grid environments, such as, for example, a peer-to-peer Virtual Tape System (“VTS”), tape products attached to the same master console, and ultimately, machines in the same domain. Currently, International Business Machine (“IBM”) commercially provides a tape product call home process whereby a machine of the enterprise network is capable of providing data corresponding to itself to an IBM offsite support system. While such data provides the IBM offsite support system with specific knowledge of the corresponding machine, the IBM offsite support system has a need to additionally obtain a proper understanding of the infrastructure of the enterprise network, particularly its machine grid implementation(s), without a requirement to be online and attached to the enterprise network.

### SUMMARY OF THE INVENTION

The present invention provides new and unique offsite enterprise support system implementing a method for detecting an infrastructure of an enterprise network.

One form of the present invention is a computer readable medium tangibly embodying a program of machine-readable instructions executable by a processor to perform operations for an offsite detection of an infrastructure of an enterprise network. The operations comprise parsing a plurality of enterprise machine data files into an offsite database supporting a logical linkage of each enterprise network interconnection among a plurality of machines of the enterprise network, and generating one or more enterprise network infrastructure profiles of the enterprise network based on the offsite database logical linkage of each enterprise network interconnection among the plurality of machines of the enterprise network.

A second form of the present invention is an offsite enterprise support system comprising: a processor; and a memory storing instructions operable with the processor for an offsite detection of an infrastructure of an enterprise network. The instructions are executed for parsing a plurality of enterprise machine data files into an offsite database supporting a logical linkage of each enterprise network interconnection among a plurality of machines of the enterprise network, and generating one or more enterprise network infrastructure profiles of the enterprise network based on the offsite database logical linkage of each enterprise network interconnection among the plurality of machines of the enterprise network.

A third form of the present invention is a method for an offsite detection of an infrastructure of an enterprise network. The method involves parsing a plurality of enterprise machine data files into an offsite database supporting a logical linkage of each enterprise network interconnection among a plurality of machines of the enterprise network, and generating one or more enterprise network infrastructure profiles of the enterprise network based on the offsite database logical linkage of each enterprise network interconnection among the plurality of machines of the enterprise network.

The aforementioned forms and additional forms as well as objects and advantages of the present invention will become further apparent from the following detailed description of the various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates one embodiment of an enterprise environment in accordance with the present invention;

FIG. 2 illustrates a flowchart representative of one embodiment of an enterprise machine data file processing method in accordance with the present invention;

FIG. 3 illustrates a flowchart representative of one embodiment of an offsite enterprise infrastructure profile generation method in accordance with the present invention;

FIG. 4 illustrates an exemplary embodiment of the enterprise environment illustrated in FIG. 1 in accordance with the present invention;

FIG. 5 illustrates a flowchart representative of an exemplary embodiment of the enterprise machine data file processing method illustrated in FIG. 2 in accordance with the present invention;

FIG. 6 illustrates a flowchart representative of an exemplary embodiment of the offsite enterprise infrastructure profile generation method illustrated in FIG. 3 in accordance with the present invention;

FIG. 7 illustrates an exemplary database listing of parsed enterprise machine data files in accordance with the present invention;

FIG. 8 illustrates an exemplary logical linking of the machines of an enterprise network in accordance with the present invention; and

FIGS. 9-12 illustrate exemplary generations of enterprise network infrastructure profiles in accordance with the present invention.

### DETAILED DESCRIPTION OF THE PRESENT INVENTION

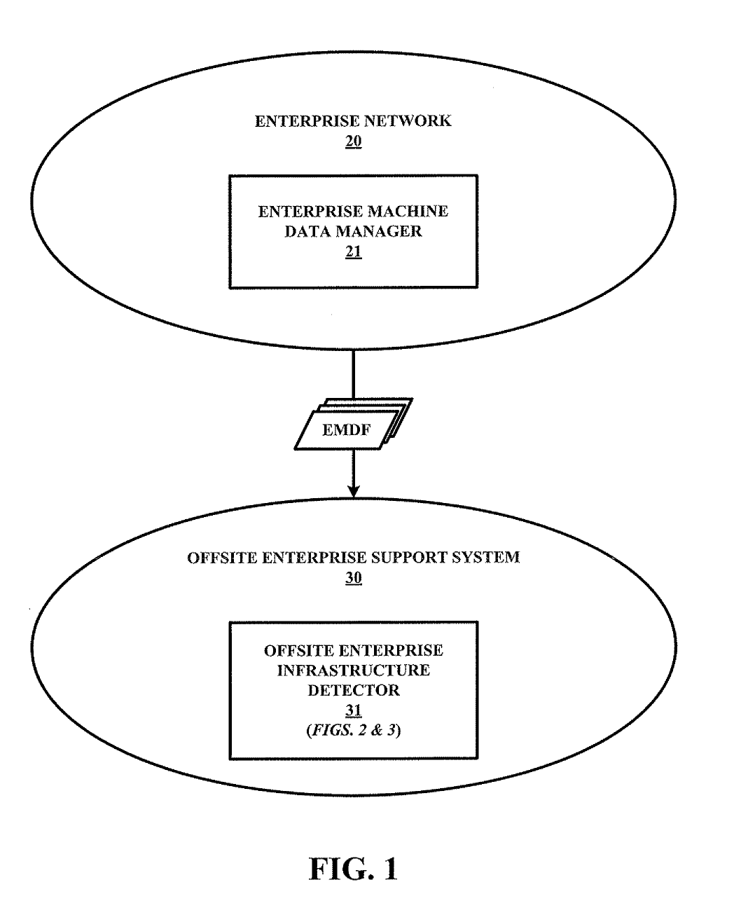

FIG. 1 illustrates an enterprise network 20 and an offsite enterprise support system 30. Enterprise network 20 employs a plurality of machines (not shown) interconnected in accordance with an infrastructure specification of enterprise network 30, such as, for example, an Ethernet network connection, a storage network ESCON/FICON connection and any over available connectivity technology as would be appreciated by those having ordinary skill in the art. Offsite enterprise support system 30 employs a plurality of machines for purposes of providing maintenance and support to enterprise network 20 at an offsite location as would be appreciated by those having ordinary skill in the art. More particularly, each machine of enterprise network 20 incorporates an enterprise machine data manager 21 for generating an enterprise machine data file EMDF including information indicative of each enterprise network interconnection of the machine, and offsite enterprise support system 30 incorporates an offsite enterprise infrastructure detector 31 of the present invention for purposes of detecting the enterprise infrastructure primarily, if not exclusively, from the enterprise network interconnection information included within each enterprise machine data file.

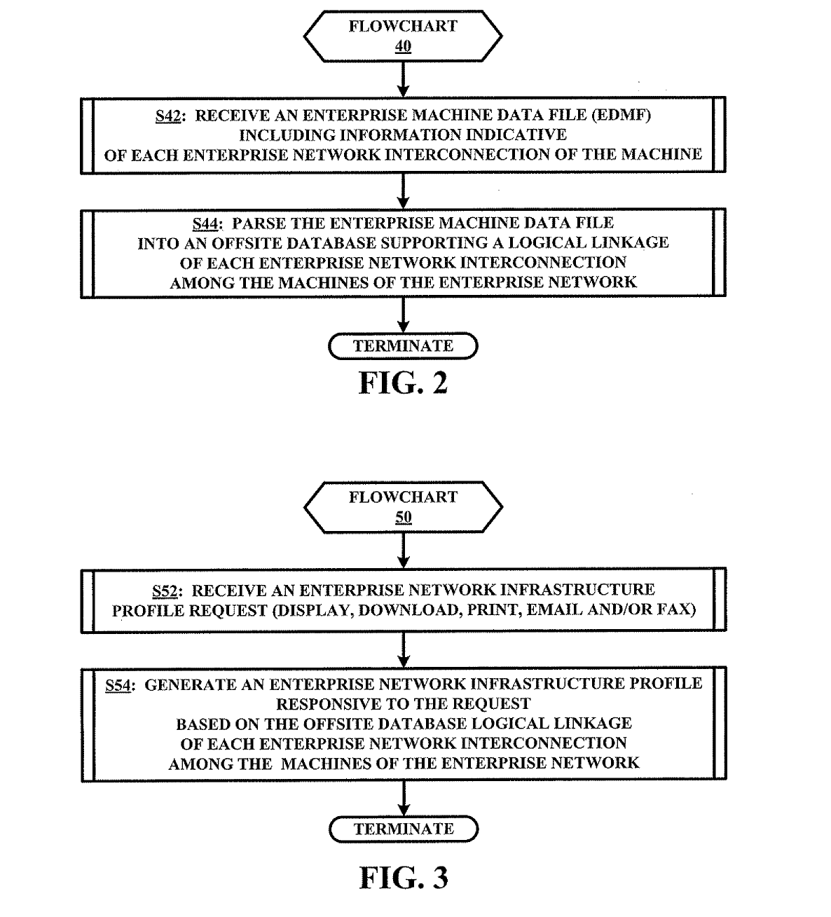

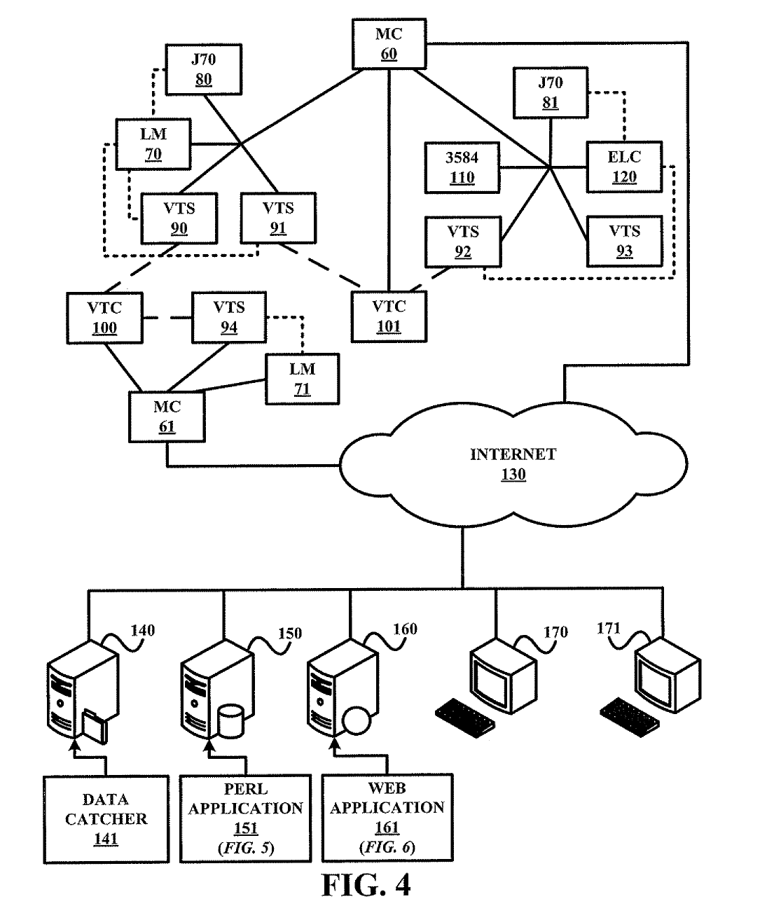

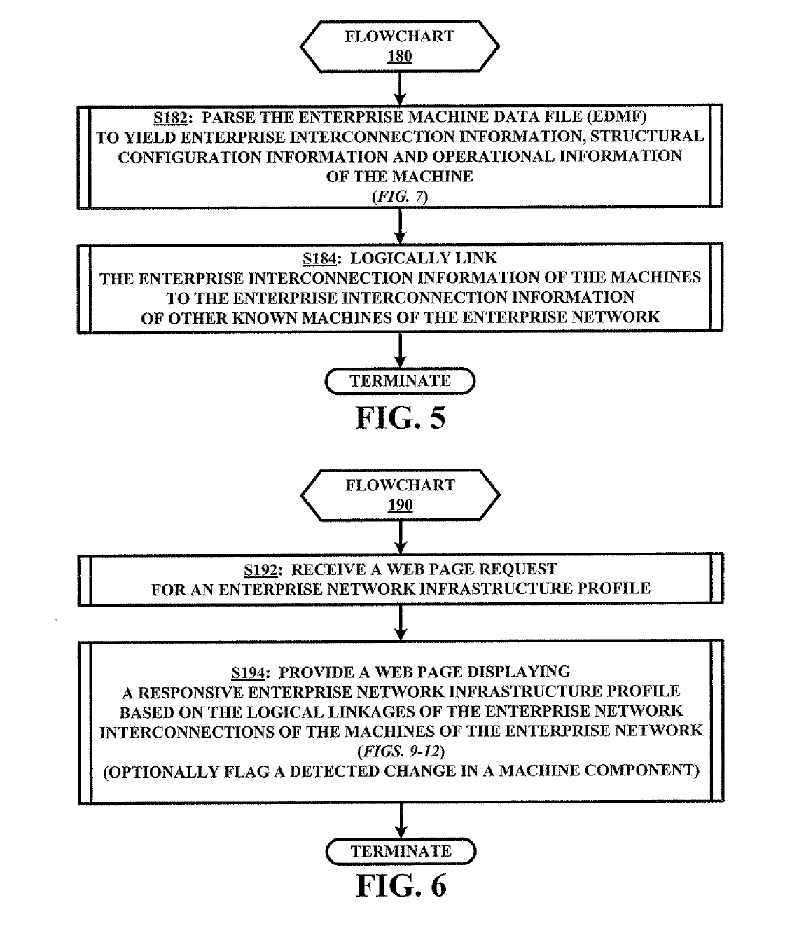

In one embodiment, offsite enterprise infrastructure detector 31 implements an enterprise machine data file processing method of the present invention as represented by a flowchart 40 illustrated in FIG. 2 and an offsite enterprise infrastructure profile generation method of the present invention as represented by a flowchart 50 illustrated in FIG. 3.

Referring to FIGS. 2 and 3, a stage S42 of flowchart 40 encompasses detector 31 receiving an enterprise machine data file EMDF from a machine of enterprise network 20 with the received enterprise machine data file EMDF including information indicated of each enterprise network interconnection of the machine as well as any other additional information relevant to an operation of system 30 as would be appreciated by those having ordinary skill in the art. In one embodiment, enterprise machine data manager 21 for each machine is a RMSS Call Home Application commercially provided by the assignee of the present invention.

A stage S44 of flowchart 40 encompasses detector 31 parsing the received enterprise machine data file EMDF into an offsite database (not shown) supporting a logical linkage of each enterprise network interconnection among all of the machines of enterprise network 20. In one embodiment, detector 31 incorporates a customized Practical Extraction and Report Language (“PERL”) program for parsing the enterprise machine data file EMDF into a DB2® Universal Database™ commercially provided by the assignee of the present invention that is structurally configured to logical link each enterprise network interconnection among all of the machines of enterprise network 20.

Those having ordinary skill in the art will appreciate that detector 31 will receive enterprise machine data files EMDF from enterprise network 30 in a periodic manner and/or random manner. In either case, a stage S52 of flowchart 50 encompasses detector 31 receiving an enterprise network infrastructure profile request at any time. The request may be in the form of a display request, a download request, a print request, an email request and/or a fax request of a profile of a portion or an entirety of enterprise network 20.

Stage S54 of flowchart 50 encompasses detector 31 generating an enterprise network infrastructure profile responsive to the request based on the offsite database logical linkage of each enterprise network interconnection among the machine of enterprise network 20 at the time of a receipt of the request.

To facilitate a further understanding of the present invention, FIG. 4 illustrates an enterprise network consisting of a pair of master consoles (“MC”) 60 and 61, a pair of library managers (“LM”) 70 and 71, a pair of J70 machines 80 and 81, five (5) virtual tapes systems (“VTS”) 90-94, a pair of virtual tape controllers (“VTC”) 100 and 101, a 3584 machine 110 and an enterprise library controller (“ELC”) 120. An Ethernet MC network of the enterprise network consists of machines 60, 81, 92, 93 and 110 connected to enterprise library controller 120. A network based on master console 60 consists of machines 70, 80, 81, 90-94, 101, 110 and 120 connected to master console 60. A P2P complex consists of machines 70, 71, 90, 94 and 100.

Master consoles 60 and 61 are connected to an internet 130, which is further connected to an offsite enterprise support system employing a file server 140, a DB2® database server 150, a web server 160 and a pair of workstations 170 and 171. File server 140 is configured with a data catcher 141 for receiving and properly distributing all incoming data files from internet 130 on behalf of the offsite enterprise support system including all enterprise machine data files EDMF (FIG. 1) provided by the machines of the enterprise network. DB2® database server 150 is configured with a PERL application 151 for implementing an enterprise machine data file processing method of the present invention represented by a flowchart 180 shown in FIG. 5. Web server 160 is configured with a web application 161 for implementing an offsite enterprise infrastructure profile generation method of the present invention represented by a flowchart 190 shown in FIG. 6.

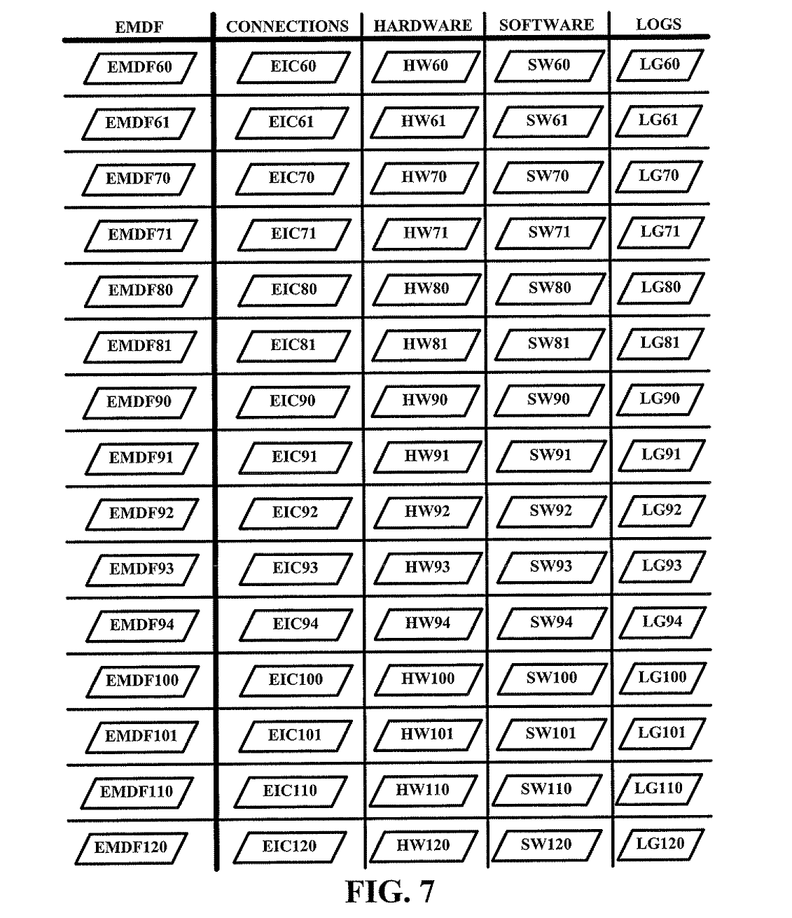

Referring to FIG. 5, PERL application 151 initiates flowchart 180 upon receiving an enterprise machine data file EDMF from data catcher 141. A stage S182 of flowchart 180 encompasses PERL application 151 parsing a received enterprise machine data file EDMF to yield enterprise interconnection information, structural configuration information and operational information of the machine. In one embodiment as illustrated in FIG. 7, PERL application 151 parses a received enterprise machine data file EDMF into enterprise interconnection information EIC, hardware configuration information HW, software configuration information SW and log information LG.

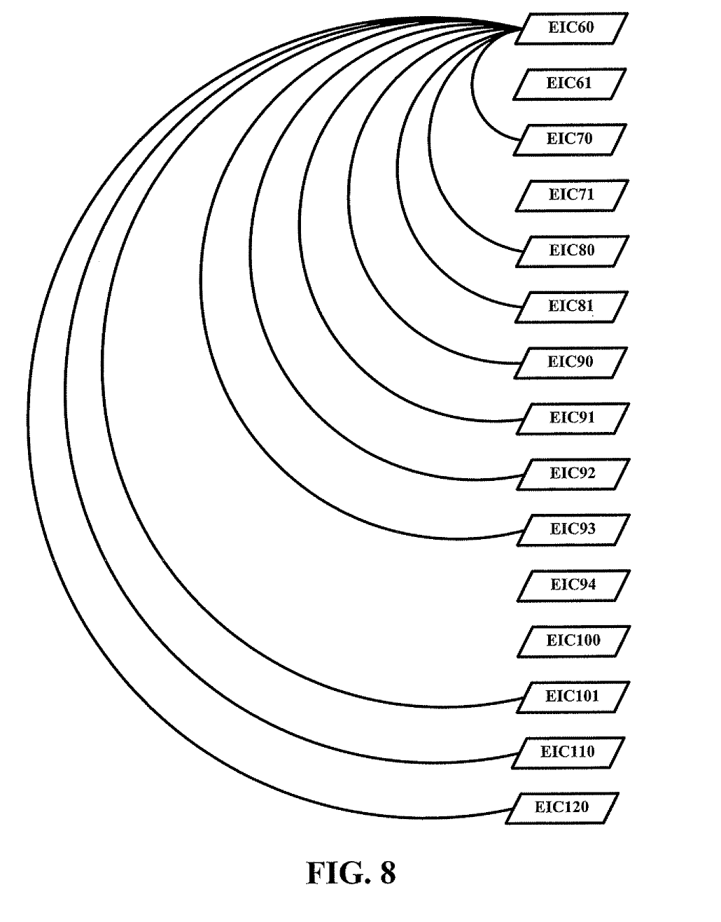

A stage S184 of flowchart 180 encompasses PERL application 151 logically linking the enterprise connection information of a machine to the enterprise connection information of other known machines of the enterprise network as exemplary illustrated in FIG. 8 for master console 60. In one embodiment, one or more database tables or relationships are defined where each row represents a particular connection between two machines as well as the type of connection.

Those having ordinary skill in the art will appreciate that PERL application 151 will receive enterprise machine data files EMDF from the machines of enterprise network in a periodic manner and/or random manner. In either case, a stage S1192 of flowchart 190 encompasses WEB application 161 receiving a web page request from one of the workstations 170 and 171 for an enterprise network infrastructure profile request. The request can occur at any time, such as, for example, prior to or subsequent to PERL application 151 receiving an initial enterprise machine data file EMDF from each machine of the enterprise network. The request can further be for a complete view of the enterprise network or a view of a subnetwork of the enterprise network.

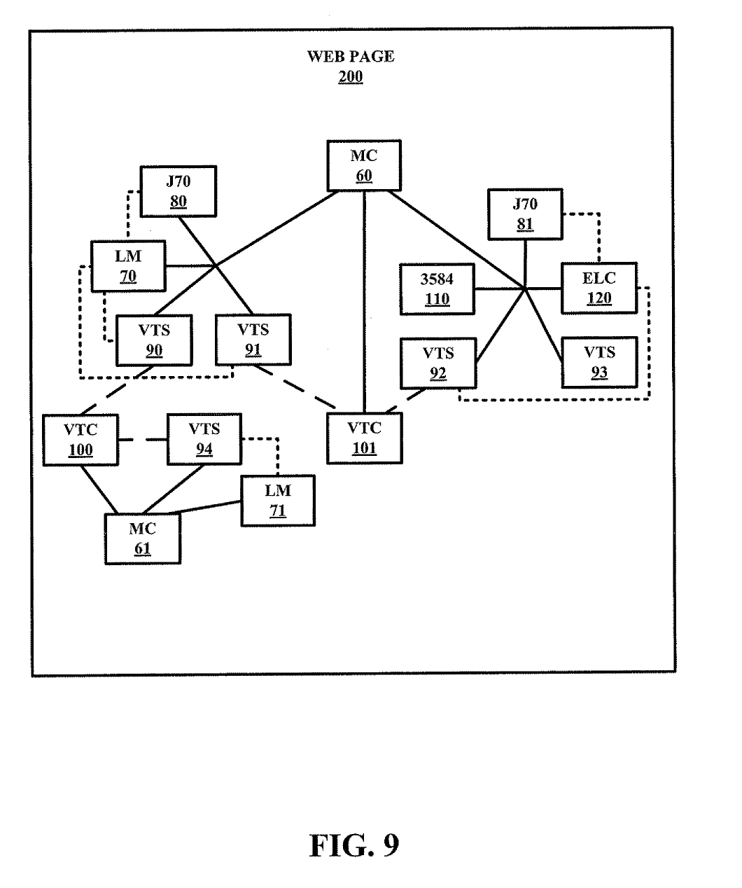

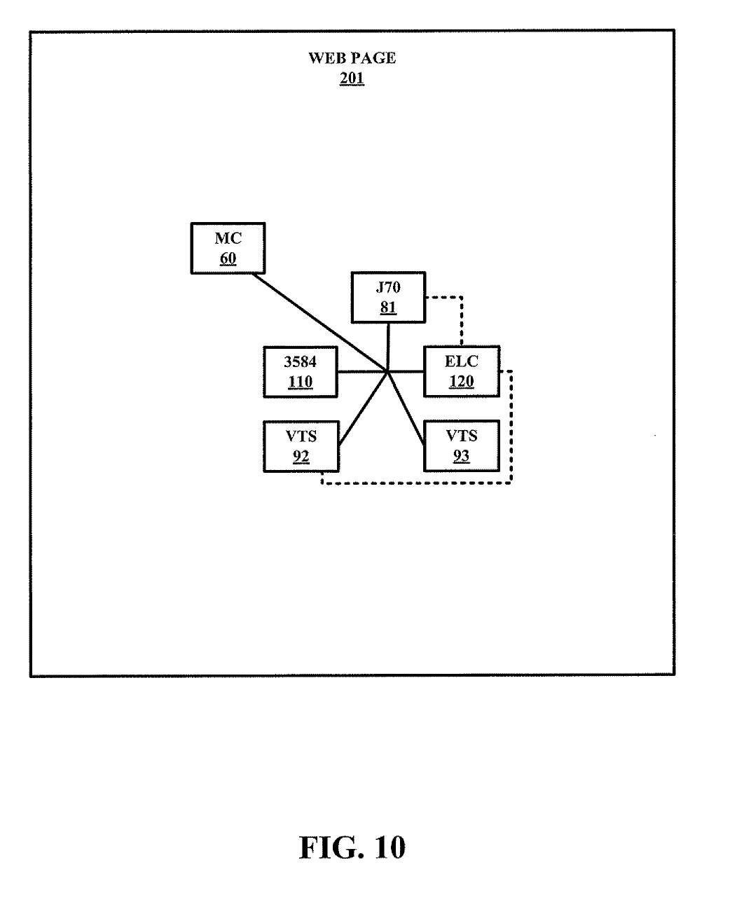

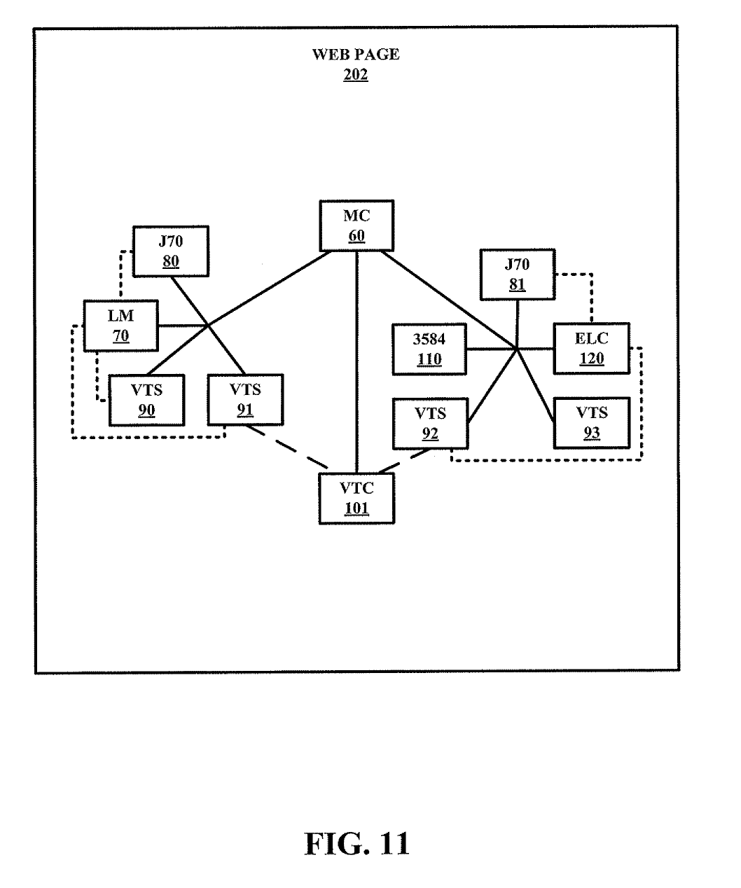

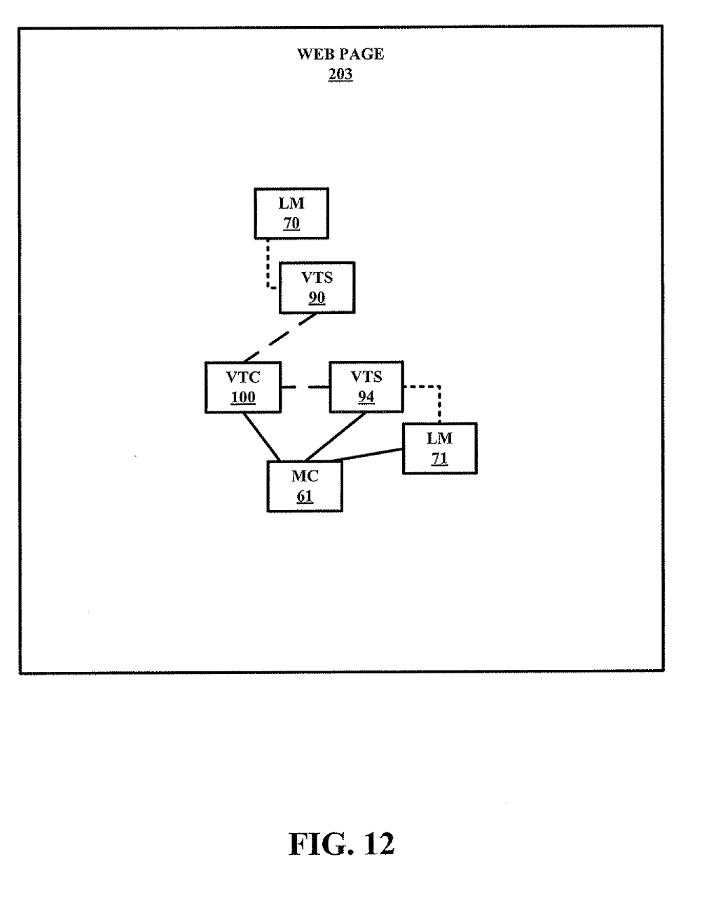

A stage S194 of flowchart 190 encompasses web application 161 providing a web page displaying a responsive enterprise network infrastructure profile based on the logical linking of the enterprise network interconnection information, such as, for example, web pages 200-203 illustrated in FIGS. 9-12, respectively. Specifically, web page 200 shown in FIG. 9 is responsive to a request for a complete view of the enterprise network, web page 201 shown in FIG. 10 is responsive to a request for a complete view of the Ethernet MC network, web page 202 shown in FIG. 11 is responsive to a request for a complete view of local site network, and web page 203 shown in FIG. 12 is responsive to a request for a complete view of a Peer-To-Peer complex. Zoom in and zoom out functions can be provided for each web page 200-203. In one embodiment, each machine icon displayed on a web page serves as a link to obtaining the structural information and log information of the machine.

Furthermore, a each detected change in a machine component (e.g., an addition, removal, replacement or upgrade of the component) can be flagged on the web page whereby a user of the web page can further determine the reason for the change in the machine component. For example, a current call home report for a code level of a machine software component can be 1.7 and a previous call home report for the same code level on the machine software component can be 1.2 whereby a flag indicating a code level upgrade of 1.2 to 1.7 on the machine is generated on the web page. Thus, the code level upgrade will be flagged when the web page is displayed whereby a user of the web page can also connect to any error call homes to see if the code level was upgraded due to a code problem. Also by example, an old tape drive in a tape library is swapped for a new tape drive whereby a current call home report indicated the new tape drive has a serial number of 54321 and a previous call home report indicates the old tape drive had a serial number of 12345. Thus, the tape drive swap will be flagged when the web page is displayed whereby a user of the web page can also connect to a problem record to see if the tape drive swap was due error to an error or for some other reason. A further example would be a flagging of six (6) new tape drives in a tape library on the web page in response to a current call home report and a previous call home report indicating an increase from six (6) tape drives as reported in the previous call home report to twelve (12) tape drives as reported in the current call home report.

Referring to FIGS. 1-11, those having ordinary skill in the art will appreciate various benefits and advantages of the present invention, including, but not limited to, (1) an ability of an offsite enterprise support system to provide an up-to-date view of a portion or an entirety of an enterprise network without requiring the offsite enterprise support system to be online and attached to the enterprise network, and (2) ability to flag a change in an operational status of a hardware component or a software component of a machine that can be linked to a problem record to see why the operational status of the hardware component or the software component of the machine was changed, particularly if the change was to a failure of the component.

The term “processor” as used herein is broadly defined as one or more processing units of any type for performing all arithmetic and logical operations and for decoding and executing all instructions related to facilitating an implementation by an offsite enterprise support system of the various methods of the present invention. Additionally, the term “memory” as used herein is broadly defined as encompassing all storage space in the form of computer readable mediums of any type within an offsite enterprise support system, particularly computer readable mediums embodying a program of machine-readable instructions executable by the processor.

Furthermore, those having ordinary skill in the art of offsite enterprise support techniques may develop other embodiments of the present invention in view of the inventive principles of the present invention described herein. Thus, the terms and expression which have been employed in the foregoing specification are used herein as terms of description and not of limitations, and there is no intention in the use of such terms and expressions of excluding equivalents of the features shown and described or portions thereof, it being recognized that the scope of the present invention is defined and limited only by the claims which follow.

We claim:

1. A computer bearing medium tangibly embodying a program of machine-readable instructions executable by a processor to perform operations for an offsite detection of an infrastructure of an enterprise network, the operations comprising:
parsing a plurality of enterprise machine data files into an offsite database supporting a logical linkage of each enterprise network interconnection among a plurality of machines of the enterprise network; and
generating an enterprise network infrastructure profile of the enterprise network based on the offsite database logical linkage of each enterprise network interconnection among the plurality of machines of the enterprise network.

2. The computer bearing medium of claim 1, wherein the parsing of the plurality of enterprise machine data files into the offsite database supporting the logical linkage of each enterprise network interconnection among the plurality of machines of the enterprise network includes:
receiving a first enterprise machine data file at an offsite location, the first enterprise machine data file including enterprise interconnection information indicative of each enterprise network interconnection of a first machine; and
parsing the first enterprise machine data file into the offsite database.

3. The computer bearing medium of claim 2, wherein the first enterprise machine data file further includes at least structural configuration information indicative of a structural configuration of the first machine and operational information indicative of an operation of the first machine.

4. The computer bearing medium of claim 3, wherein the first enterprise machine data file is parsed into the enterprise connection information, hardware configuration information, software configuration information and log information.

5. The computer bearing medium of claim 1, wherein the generating of the enterprise network infrastructure profile of the enterprise network based on the offsite database logical linkage of each enterprise network interconnection among the plurality of machines of the enterprise network includes:
receiving a web page request for the enterprise network infrastructure profile; and
providing a web page displaying the enterprise network infrastructure profile.

6. The computer bearing medium of claim 5, wherein the enterprise network infrastructure profile displayed by the web page is of subnetwork within the enterprise network.

7. The computer bearing medium of claim 5, wherein the enterprise network infrastructure profile displayed by the web page includes a flagging of each detected change in least one component of at least one machine.

8. An offsite enterprise support system, comprising:
a processor; and
a memory storing instructions operable with the processor for an offsite detection of an infrastructure of an enterprise network, the instructions are executed for:
parsing a plurality of enterprise machine data files into an offsite database supporting a logical linkage of each enterprise network interconnection among a plurality of machines of the enterprise network; and
generating an enterprise network infrastructure profile of the enterprise network based on the offsite database logical linkage of each enterprise network interconnection among the plurality of machines of the enterprise network.

9. The offsite enterprise support system of claim 8, wherein the parsing of the plurality of enterprise machine data files into the offsite database supporting the logical linkage of each enterprise network interconnection among the plurality of machines of the enterprise network includes:
receiving a first enterprise machine data file at an offsite location, the first enterprise machine data file including enterprise interconnection information indicative of each enterprise network interconnection of a first machine; and
parsing the first enterprise machine data file into the offsite database.

10. The offsite enterprise support system of claim 9, wherein the first enterprise machine data file further includes at least structural configuration information indicative of a structural configuration of the first machine and operational information indicative of an operation of the first machine.

11. The offsite enterprise support system of claim 10, wherein the first enterprise machine data file is parsed into the enterprise connection information, hardware configuration information, software configuration information and log information.

12. The offsite enterprise support system of claim 8, wherein the generating of the enterprise network infrastructure profile of the enterprise network based on the offsite database logical linkage of each enterprise network interconnection among the plurality of machines of the enterprise network includes:
receiving a web page request for the enterprise network infrastructure profile; and
providing a web page displaying the enterprise network infrastructure profile.

13. The offsite enterprise support system of claim 12, wherein the enterprise network infrastructure profile displayed by the web page is of subnetwork within the enterprise network.

14. The offsite enterprise support system of claim 12, wherein the enterprise network infrastructure profile displayed by the web page includes a flagging of each detected change in least one component of at least one machine.

15. A method for an offsite detection of an infrastructure of an enterprise network, the method comprising:
parsing a plurality of enterprise machine data files into an offsite database supporting a logical linkage of each enterprise network interconnection among a plurality of machines of the enterprise network; and
generating an enterprise network infrastructure profile of the enterprise network based on the offsite database logical linkage of each enterprise network interconnection among the plurality of machines of the enterprise network.

16. The method of claim 15, wherein the parsing of the plurality of enterprise machine data files into the offsite database supporting the logical linkage of each enterprise network interconnection among the plurality of machines of the enterprise network includes:
receiving a first enterprise machine data file at an offsite location, the first enterprise machine data file including enterprise interconnection information indicative of each enterprise network interconnection of a first machine; and
parsing the first enterprise machine data file into the offsite database.

17. The method of claim 16, wherein the first enterprise machine data file further includes at least structural configuration information indicative of a structural configuration of the first machine and operational information indicative of an operation of the first machine.

18. The method of claim 17, wherein the first enterprise machine data file is parsed into the enterprise connection information, hardware configuration information, software configuration information and log information.

19. The method of claim 15, wherein the generating of the enterprise network infrastructure profile of the enterprise network based on the offsite database logical linkage of each enterprise network interconnection among the plurality of machines of the enterprise network includes:
receiving a web page request for the enterprise network infrastructure profile; and
providing a web page displaying the enterprise network infrastructure profile.

20. The method of claim 19, wherein the enterprise network infrastructure profile displayed by the web page is of subnetwork within the enterprise network.

21. The method of claim 19, wherein the enterprise network infrastructure profile displayed by the web page includes a flagging of each detected change in least one component of at least one machine.
